(19) United States
(12) Patent Application Publication
(10) Pub. No.: US 2003/0168874 A1
(43) Pub. Date: Sep. 11, 2003

(54) Cargo shell with removable roof ramp panels

(76) Inventor: Mo A. Bautista JR., Mission Viejo, CA (US)

Correspondence Address: Mo A. Bautista Jr., 15 Ashton, Mission Viejo, CA, 92692, US

(21) Appl. No.: 10/094,366

(22) Filed: Mar. 9, 2002

(51) Int. Cl. B60P 3/42

(52) U.S. Cl. 296/10; 296/61; 414/537

(57) ABSTRACT

A cargo enclosure with removable roof panels that can be used as ramps to load and unload heavy items. Each roof panel is built such that it can support a heavy load being translated over it. The cargo shell capable of being locked with or without the roof panels installed in a variety of means known to those experienced in the art.

### BACKGROUND OF THE INVENTION

1. Field of the Invention

This invention relates to pickup truck cargo shells, and more specifically to one that has removable roof panels that can also be used as loading ramps. The concept is also adaptable to a trailer type vehicle. In a situation where an oversized item needs to be loaded, the roof panels are removed and stored with provisions on the inside side panels of the shell or in the cargo area. The aft access panel is fully lockable with or without the roof panels.

2. Description of the Prior Art

Many truck bed covers have been granted since the birth of the pickup truck. From simple ones that provide either the basic non-moveable shell, to a flat cover design such as tonneau covers. The non-moveable shells come in different heights, widths, styles, colors, and materials depending on personal preference and intended use. These shells are available for any pickup truck manufactured today. The shells incorporated many other features in the later years. Options such as openable side panels, fixed or sliding windows, forward tilt, side tilt, collapsible tents, lockable rear entrance, compartments, bare interior or with liners, top-bottom split or side-by-side rear entrance, and openable and/or removable roof panels.

The purpose of today's pickup truck is multi-functional. Many owners use these vehicles to store equipment for personal businesses, haul personal belongings, haul home improvement items, and transport personal recreational vehicles or any combination of these throughout the week

In an event where owners need to haul an oversized load, they must remove the entire shell of a conventional enclosure. They feel it more of a hindrance to have one on because it is cumbersome to take off and put back on again. Thus, many pickup truck owners choose not to install any type of cover or shell at all.

The idea of accommodating oversized cargo has been addressed by several patents. U.S. Pat. No. 5,403,061 dated Apr. 4, 1995 granted to Micknowicz and U.S. Pat. No. 5,131,712 dated Jul. 21, 1992 granted to Heinz are two of many examples of a side tilt cargo shell. The size of the cargo is somewhat limited by the height one could slide through when the shell is fully tilted on its side. Once the tall item is placed, the shell may or may not be fully closed. This is not an ideal situation.

U.S. Pat. No. 5,595,418 dated Jan. 21, 1997 granted to Medlin and U.S. Pat. No. 5,421,633 dated Jun. 6, 1995 granted to Moore et.al., are two of many examples depicting a forward tilt shell. This idea will also allow oversized items to be loaded in the cargo area. Unfortunately, like the side tilt model, this forward tilting shell also limits the height of cargo the owner can load.

A better design of prior art is illustrated in U.S. Pat. No. 5,209,543 dated May 11, 1993 granted to Harkins and U.S. Pat. No. 5,016,935 dated May 21, 1991 granted to Semple. These feature an openable roof panel that virtually allows a cargo of any height to be loaded. The roof panels are equally split lengthwise and are hinged on their outer side so as to allow the panel to be swung upward and outward. These two of many similar arts can be improved upon by making use of the roof panels.

The present invention addresses the shortfalls of all the prior art in dealing with oversized items, as does U.S. Pat. No. 5,518,288 dated May 21, 1996 granted to Deklotz. The disadvantage of Deklotz's idea is that the shells rear entrance is very large. This is unfavorable for everyday use. The owner would much rather prefer a smaller opening inherent of the top-bottom split or side-by-side rear entrances.

### 3. ADVANTAGES OF THE PRESENT INVENTION

Therefore, the present invention, which has the best attributes of all prior arts that accommodates oversized items, is most favorable. The present invention will serve as a conventional cargo shell whereby the owner can load and unload everyday items with ease and be able to secure the items in the shell with a locking mechanism known by those experienced in the art. When there is a need to load an oversized item, the owner will not need to remove the entire shell. The owner would simply detach one or both roof panels, and load the tall item. The ramps can be stored in a designated location on the shell or in the cargo area if the tall item prevents it from being replaced back on the roof location. This valuable cargo can then be secured by locking the rear entrance. If the item is oversized and heavy, the owner can use the roof panels as ramps. The ramps are positioned according to well known means, typically by securing to the flat surface of the bed or a surface on the same relative plane as the truck bed. The heavy oversized item can be first loaded on a wheeled carrier or dolly and rolled up the ramps.

It is very advantageous to use the present design in transporting personal recreational vehicles, such as motorcycles, all-terrain vehicles, and personal watercraft. Consumers typically load their recreational vehicles such as motorcycles on the open cargo area using narrow ramps. These narrow ramps are not much wider than the motorcycle tires. The rider has to push the motorcycle up the narrow ramp while walking or running alongside on the ground. As the motorcycle rises up the ramp, the rider has to find a technique to elevate himself onto the cargo bed without causing injury to himself and without damaging his motorcycle. In addition, once the motorcycle is tied down on the cargo bed, the rider is not able to secure them in any way. The present invention will provide a way of loading via the roof ramp panels. The roof ramp panels will be wide enough so that the rider can walk on the ramp alongside his motorcycle as he pushes it up onto the cargo area. Since there are two roof ramp panels available, the popular four wheel cycles can be loaded onto the cargo area with ease. After the vehicles are loaded onto the cargo area, the ramps can be replaced back on the roof and the entire enclosure can be locked-up. Securing these valuable assets especially when the pickup truck is left unattended for a lengthy period of time, such as overnight, is another welcome feature of the present invention.

For the consumer who owns a sport utility vehicle (SUV) and wishes to transport their personal recreational vehicles, a trailer version of the present invention is a favorable over an open trailer already in production. Since an SUV does not have an open cargo area, owners of this vehicle must pull a trailer if they wish to transport their personal recreational vehicles. Trailer manufacturers offer specific styles to accommodate the consumers needs. If the consumer wishes to transport motorcycles, a trailer specifically made for this purpose is offered. A motorcycle trailer is usually constructed without an enclosure. It is usually a simple trailer framework with fixed rails where the motorcycle wheels are positioned and tied down. This open version does not have any security features. An enclosed motorcycle trailer is usually a very tall box structure since the height is required for headroom. This enclosed version does have a security feature. The open type trailer is favored over the enclosed one due to it's compactness an lesser wind resistance. The trailer version of the present invention combines the best of both trailers now in production. The present invention can be manufactured just tall enough to accommodate the height of the motorcycles. Since the roof panels are removable, the trailer can be made compact and since the trailer of the present invention is enclosed, the security feature is available. Owners of the open type motorcycle trailer normally removes their motorcycle from said trailer and store them in an enclosed structure to protect them from the weather and out of view from the public. The trailer version of the present invention would serve as this storage structure.

### BRIEF DESCRIPTION OF THE DRAWINGS

Since all pickup truck camper top or cargo shell manufacturers are established in fabricating the art, it is not the intent of this invention to define how the present invention should be made. Each individual manufacturer of the art may prefer to fabricate the present invention using their unique style, methods and/or hardware. Rather, it is the object of the present invention to introduce the idea of using removable roof panels and use them as loading ramps. The invention will be described with a preferred embodiment, but it will be understood that it is not intended to limit the invention to that embodiment. Instead, it is intended to cover all alternatives, equivalents and modifications as may be included within the spirit and scope of the invention as defined by the appended claim. The attached figures will identify the various configurations the present invention can be fabricated as.

FIG. 1 is a perspective view of the present invention. It illustrates a vacant roof area, a front panel (2), side panels (3a-3b), and the roof panels (6a, 6b) being used as ramps resting on the tailgate (5) of a pickup truck (1). This shell uses the existing tailgate (5) in its closed position as part of the entire enclosure's locking feature. The top half (7) of the rear entrance is removable, as is the rear horizontal support structure (12) for complete access to loading area (4). Windows are optional features and may be located on any one or any combination of the enclosures four main panels; 2, 3a, 3b, and 7. On FIGS. 2 and 4, components 8a and 8b replace component 7 and 5. Thus, windows may be located on components 8a and 8b on FIGS. 2 and 4.

FIG. 2 is similar to FIG. 1 except that the rear entrance (8a, 8b) is a side-by-side split configuration. The tailgate (5) is eliminated in this version.

FIG. 3 illustrates a trailer version (11) of the present invention. The rear entrance (7,5) is a top-bottom-split design. All other components are described in FIG. 1 above.

FIG. 4 illustrates a trailer version (11) similar to FIG. 3 except with a side-by-side (8a, 8b) rear entrance. All other components are described in FIG. 1 above.

FIG. 5 illustrates the trailer version (11) with auxiliary compartments (10a, 10b) designed in. All other components are described in FIG. 1 above.

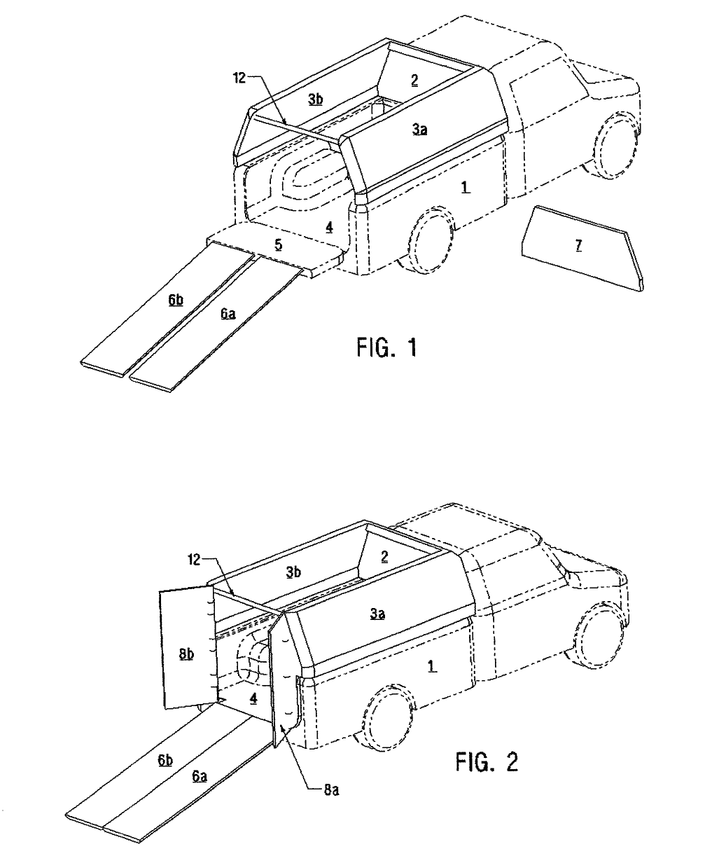

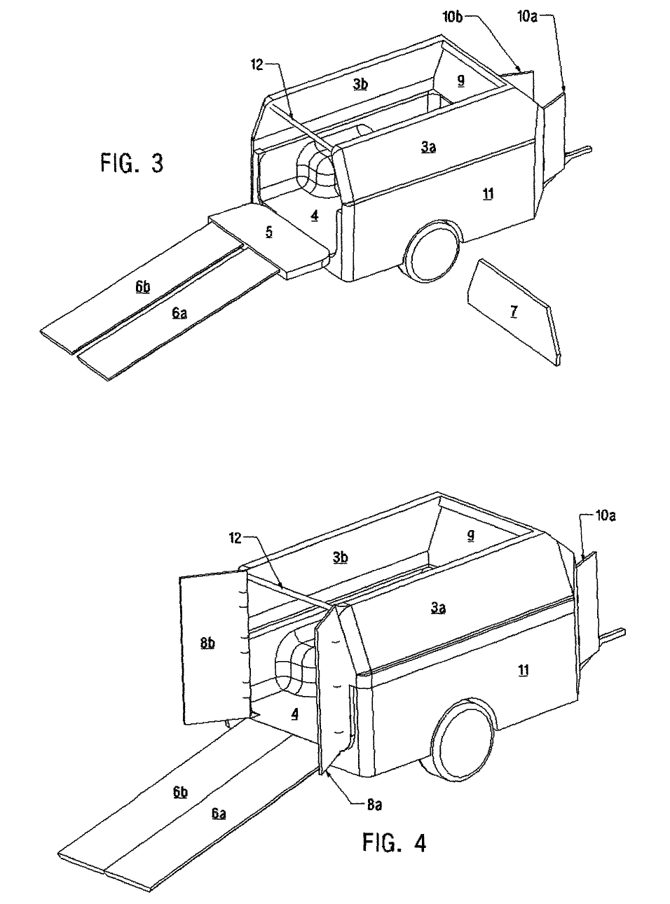

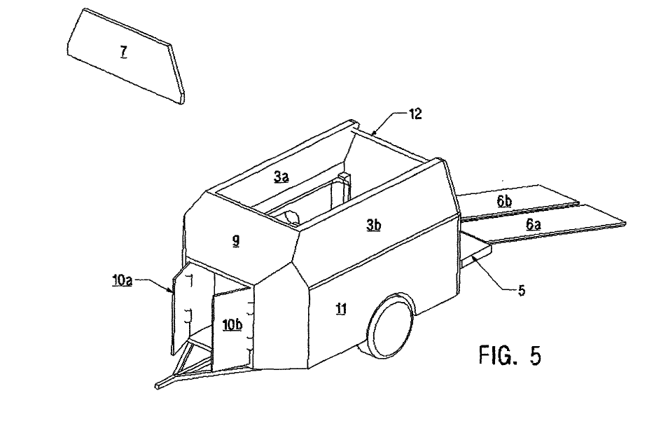

### CONCLUSION AND CLAIMS

The discussed illustrations should not be construed as limitations on the scope of this invention, but rather as an exemplification of several preferred embodiments thereof. Many other variations are possible. For example, a great variety of methods and hardware are available to attach the top swing rear entrance or the side-by-side rear entrance. The rear entrance may be opened and removed by sliding, swinging, raising, and or dropping for quick access to the cargo area. Similarly, those experienced in the art may choose their own way to design how the roof panels are styled and secured to the top of the shell. Likewise, the ramp design and load ratings are left to the discretion of those experienced in the art.

In conclusion, it is the object of the present invention to provide the public a cargo area enclosure that allows transport of oversized items, provide ramps for loading and unloading heavy items and provide a means of securing items.

Although the present invention has been described with respect to a preferred embodiment thereof, it is to be understood that it is not to be so limited since changes and modifications can be made therein which are within the full intended scope of this invention as defined by the appended claims.

Having described the invention with the particularity set forth above, I claim:

1. A top and rear opening pickup truck cargo area (4) enclosure in which the key feature is the top or roof panels (6a, 6b) also serving as loading and unloading ramps.

2. The roof ramp panels as described in claim 1 to be a single or multiple panel design.

3. The roof ramp panels as described in claim 1 to be secured in a safe manner.

4. The roof ramp panels as described in claim 1 to have a sure grip surface on one or both sides.

5. The roof ramp panels as described in claim 1 to have or not have cargo tie down features.

6. The rear entrance of the enclosure to be lockable or secured with or without the roof ramp panels (6a, 6b) installed.

7. The rear entrances be of various methods such as, but not limited to, side-by-side (8a, 8b) or top-and-bottom split (7,5).

8. The enclosure be made of the same or different material than the roof ramp panels as described in claim 1.

9. The enclosure to be of various length, width, and height to fit all production vehicles the present invention can be adapted to.

10. The enclosure to have or not have a removable rear horizontal support structure (12).

11. The enclosure be adapted to a trailer type version (11) with claims 2 through 10 applicable.

12. The enclosure as described in claim 1 and 11 to have or not have built-in lockable or non-lockable compartments (10a, 10b) and/or windows or a multitude of same.
